(19) United States
(12) Patent Application Publication
(10) Pub. No.: US 2019/0072836 A1
(43) Pub. Date: Mar. 7, 2019

(54) COVER WINDOW FOR A DEVICE

(71) Applicant: SIRIN ADVANCED TECHNOLOGIES LTD., Tel Aviv (IL)

(72) Inventors: Gabriel KARP, Givatayim (IL); Maxim FELDMAN, Petah Tikva (IL)

(73) Assignee: SIRIN ADVANCED TECHNOLOGIES LTD., Tel Aviv (IL)

(21) Appl. No.: 15/767,232

(22) PCT Filed: Sep. 8, 2016
(86) PCT No.: PCT/IL2016/050995

§ 371 Date: Apr. 10, 2018

(30) Foreign Application Priority Data
Oct. 11, 2015 (IL) 241997

(51) Int. Cl. G03B 15/05; G03B 11/04

(52) U.S. Cl. CPC G03B 15/05; G03B 2215/0503; G03B 11/045

(57) ABSTRACT

Provided is a cover window for covering two or more optical components of a device, the cover window including: a cover member having a top surface and a bottom surface configured for facing the optical components, when the cover member is mounted to the device; at least two light transmitting regions, each disposed in registry with a viewing cone of a respective optical component; and at least one peripheral region extending between the two light transmitting regions and disposed outside the viewing cone of the respective optical components; and a light-absorbing layer disposed at least at a portion of the peripheral region.

### TECHNICAL FIELD

This presently disclosed subject matter relates to cover windows for devices, in particular, cover windows for covering optical components of the devices.

### BACKGROUND

Nowadays, more and more devices (e.g., mobile phones), include a plurality of optical components (e.g., a camera, a flash-light, a proximity sensor, etc.).

The need to minimize the dimensions of the devices, together with an increasing number of the optical components integrated therein in order to increase the functionally of the devices, can result in dense placement of the optical components. When a number of optical components are placed under a single cover window and are disposed closely to each other, they can experience crosstalks, between the optical components themselves and with the environment.

In optics, crosstalk is a phenomenon by which light related to one optical component is transmitted to another optical component, so that an undesired effect on the other optical component is caused.

In order to preserve the performance of the optical components when placed under a single cover window, there is a need to reduce the undesired influence of the optical components on each other and the undesired influence of external sources of light on the optical components, i.e., to minimize the crosstalks related to the optical components.

### SUMMARY OF THE PRESENTLY DISCLOSED SUBJECT MATTER

According to a first aspect of the presently disclosed subject matter, there is provided a cover window for covering two or more optical components of a device, said cover window comprising:

a cover member having a top surface and a bottom surface configured for facing the optical components, when said cover member is mounted to said device;

at least two light transmitting regions, each disposed in registry with a viewing cone of a respective optical component;

and at least one peripheral region extending between the two light transmitting regions and disposed outside the viewing cone of the respective optical components; and

a light-absorbing layer disposed at least at a portion of the peripheral region.

According to a second aspect of the presently disclosed subject matter, there is provided a device comprising two or more optical components and a cover window mounted thereto for covering the optical components, the cover window comprising:

a cover member having a top surface and a bottom surface configured for facing the optical components, when said cover member is mounted to said device;

at least two light transmitting regions, each disposed in registry with a viewing cone of a respective optical component;

and at least one peripheral region extending between the two light transmitting regions and disposed outside the viewing cone of the respective optical components; and

a light-absorbing layer disposed at least at a portion of the peripheral region.

According to a third aspect of the presently disclosed subject matter, there is provided a method for producing a cover window for covering two or more optical components of a device, the method comprising steps of:

obtaining a cover member having a top surface and a bottom surface configured for facing the optical components, when said cover member is mounted to said device;

defining at least two light transmitting regions, each disposed in registry with a viewing cone of a respective optical component;

defining at least one peripheral region between the two light transmitting regions and disposed outside the viewing cone of the respective optical components; and

disposing a light-absorbing layer at least at a portion of the peripheral region.

The term ‘device’ refers hereinafter in the specification and the claims to any electronic and/or optical device in which a cover member is utilized for covering optical components thereof. The device can be, for example: a mobile phone, a tablet device, a computer, a PDA, a portable audio device, a video player, a game player, a still camera, a video camera, a microscope, the like, and any sub-assembly designed for integration inside a device.

The term ‘optical component’ refers hereinafter to a component interacting with light and inputs/outputs data as a result of this interaction. The optical component can be, for example: an image sensor (e.g., CCD, CMOS), a flash (e.g., LED light source), an ambient light sensor, a time of flight sensor, a display, a proximity sensor, a spectrometer, a photo-detector, an opto-chemical sensor, an opto-biological sensor. The optical component can be used to sense light within the following spectral ranges: Ultra-Violate (UV), Visible (VIS), Near Infra-Red (NIR) Short-Wavelength Infra-Red (SWIR), Mid-Wavelength Infra-Red (MWIR) Long-Wavelength Infra-Red (LWIR)

The term ‘viewing cone’ refers hereinafter in the specification and the claims to a range of directions defined between an optical component and a field ahead of the optical component, at which an optical intersection is established with the optical component so as to allow operation of the optical component.

The term ‘layer’ refers hereinafter in the specification and the claims to a coating, a film, a membrane, or a thin and wide member applied to or integrated within a particular member (e.g., a cover member).

The cover window of the presently disclosed subject member is structured so as to reduce the crosstalks when a number of proximal optical components are placed under a single cover window. The crosstalks are resultant of light travelling within the cover window from one optical component to another neighboring optical component, or from the exterior surrounding of the cover window to one or more of the optical components. This reduction in crosstalks is provided by optically isolating the optical components from each other by reducing the amount of light that travels therein. This can be done by disposing a light-absorbing layer at a peripheral region disposed outside the viewing cones of the optical components so as to absorb light travelling at the peripheral region via the cover member. According to particular examples, the reduction in crosstalks can further be improved by applying at least one anti-reflection layer at the bottom surface and/or the top surface of the cover member, so as to increase light transmission from the cover member allowing the light that travels within the cover member to escape therefrom as much as possible.

Any one or more of the following features, designs and configurations can be incorporated in the presently disclosed subject matter according to the first aspect, the second aspect or the third aspect, independently or in combination thereof:

The light-absorbing layer can be applied to the cover member.

The light-absorbing layer can be disposed at an area of the peripheral region which is disposed between the light transmitting regions.

The light-absorbing layer can be defined by an external outline having two concave portions, each partially surrounding the respective light transmitting region of the light transmitting regions.

The light-absorbing layer can be disposed at an area that encloses the light transmitting regions.

The light-absorbing layer can be disposed at the entire area of the peripheral region.

The light-absorbing layer can be defined by: two or more internal outlines, each defining a hollow space that encloses the respective light transmitting region of the light transmitting regions; and an external outline that encloses the light transmitting regions.

The internal outlines can be characterized by one of the following shapes: a round shape, a square shape, an oval shape, or combination thereof.

The light-absorbing layer can be constituted by two or more separate light-absorbing layers, each defined by an internal outline defining a hollow space that encloses the respective light transmitting region of the light transmitting regions.

The internal outline can be characterized by one of the following shapes: a round shape, a square shape, an oval shape, or combination thereof.

When the cover window is mounted to the device, the peripheral region can be disposed at least above a spacing extending between the optical components.

The light-absorbing layer can be applied to the bottom surface of the cover member.

The cover window can further comprise at least one anti-reflection layer. The anti-reflection layer can be applied to at least one of the bottom surface and the top surface of the cover member.

The anti-reflection layer can be applied to the cover member only at the light transmitting regions.

The anti-reflection layer can be made of at least one of the following materials: Silicon (Si), Magnesium Fluoride (MgF2), Titanium (Ti), Aluminum, Silver (Ag), Gold (Au), Oxygen (O), Chlorine (Cl), Bromine (Br), Silica (SiO2), Titania (TiO3) and Alumina (Al2O3), or combination thereof.

The light-absorbing layer can be made of at least one of the following materials: etched Carbon, Titanium, Anodized Aluminum, Titanium Carbide, Carbon Nanotubes, Organic Polymers or combination thereof.

The cover member can be made of at least one of the following materials: BK7, Soda-Lime, Sapphire, Aluminosilicate, Acryl, Polyurethane, Fused Silica, ALON, Spinel, Aluminum Nitride, or combination thereof.

In the third aspect, the step of disposing the light-absorbing layer can be performed by applying light-absorbing layer to the cover member.

In the third aspect, the step of disposing the light-absorbing layer can be performed by disposing the light-absorbing layer at an area of the peripheral region between the light transmitting regions.

In the third aspect, the step of disposing a light-absorbing layer can be performed by applying the light-absorbing layer to the bottom surface of the cover member.

In the third aspect, the method can further comprise a step of applying at least one anti-reflection layer to at least one of said bottom surface and said top surface of the cover member.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A is a rear perspective view of an example of a known in the art mobile phone including two optical components covered by a single cover window;

FIG. 1B is a cross-sectional view of portion A₁ of the mobile phone of FIG. 1A taken along line A-A;

FIG. 2A is a rear perspective view of a mobile phone with a cover window, in accordance with a first example of the presently disclosed subject matter;

FIG. 2B is an enlarged view of portion A₂ of FIG. 2A;

FIG. 2C is a cross-sectional view taken along line B-B of FIG. 2B;

FIG. 2D is a cross-sectional view taken along line C-C of FIG. 2B;

FIG. 3A is a rear perspective view of a mobile phone with a cover window, in accordance with a second example of the presently disclosed subject matter;

FIG. 3B is an enlarged view of portion A₃ of FIG. 3A;

FIG. 3C is a cross-sectional view taken along line D-D of FIG. 3B;

FIG. 4A is a rear perspective view of a mobile phone with a cover window, in accordance with a third example of the presently disclosed subject matter;

FIG. 4B is an enlarged view of portion A₄ of FIG. 4A; and

FIG. 4C is a cross-sectional view taken along line E-E of FIG. 4B;

### DETAILED DESCRIPTION OF EMBODIMENTS

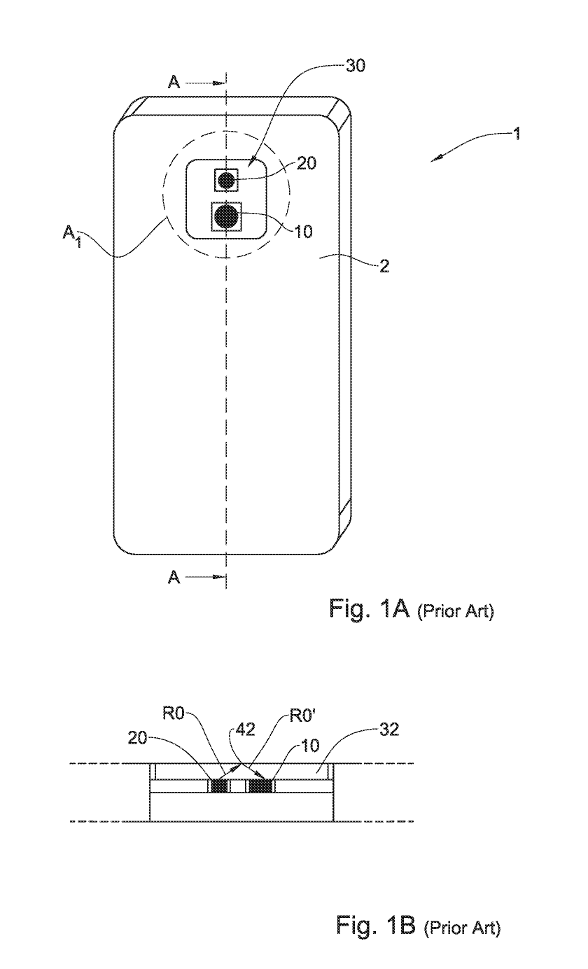

Attention is first directed to FIGS. 1A and 1B in which a prior art device in the form of a mobile phone 1 is illustrated. The mobile phone 1 includes two optical components, i.e., a camera 10 and a flash-light 20, both disposed at a rear side 2 of the mobile phone 1. The camera 10 and the flash-light 20 are disposed in proximity to each other and both covered by a single cover window 30 including a transparent cover member 32 mounted to the rear side 2. The cover member 32 is made of glass, and in particular Sapphire, and has a transmission coefficient of T=85.6% and reflectance coefficient of R=14.2%, composed of R=7.7% per surface at a wavelength of 587 nm.

In view of the existence of the cover member 32 having a relatively high reflectance coefficient, and the proximity of the camera 10 and the flash-light 20 to each other, unwanted crosstalks are generated between the camera 10 and the flash-light 20 as a result of light travelling via the cover window 30, or from the exterior surrounding of the cover window 30 to the camera 10 and/or to the flash-light 20. One example of such crass-talk issue is shown in FIG. 1B. In this figure, a ray of light R0 is generated by the flash-light 20 during its activation, and is reflected at a point 42 as a ray of light R0′, constituting 7.7% of R0. The ray of light R0′ is received at the camera 10, and influences on the signals that are generated by the camera 30. As a result of that, the quality of the image that is generated by the camera 30 is reduced.

In order to reduce, or even eliminate, the influence of the above described crosstalks, the cover window 30 should include one or more additional layers that optically isolate from each other the optical components disposed under the cover window. As suggested by the presently disclosed subject matter, this can be done by applying a light-absorbing layer at a peripheral region disposed outside the viewing cones of the optical components so as to absorb light travelling at the peripheral region via the cover member of the cover window. According to particular examples, the influence of the crosstalks can be further reduced, or even eliminated, by applying at least one anti-reflection layer at a bottom surface and/or a top surface of the cover member, so as to increase light transmission from the cover member, allowing the light to escape from the cover member and not propagate therein. As much as light transmission from the cover member is increased anti-reflection layer, there is decreased reflected light travelling within the cover member, and thereby the influence of the crosstalks is reduced.

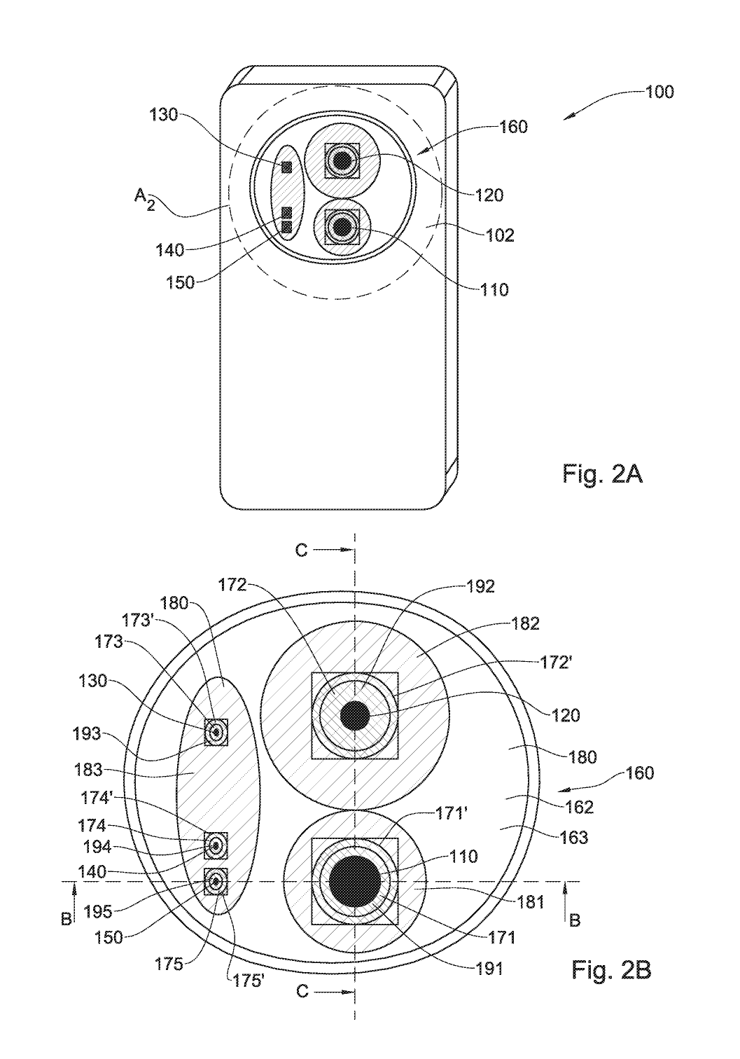

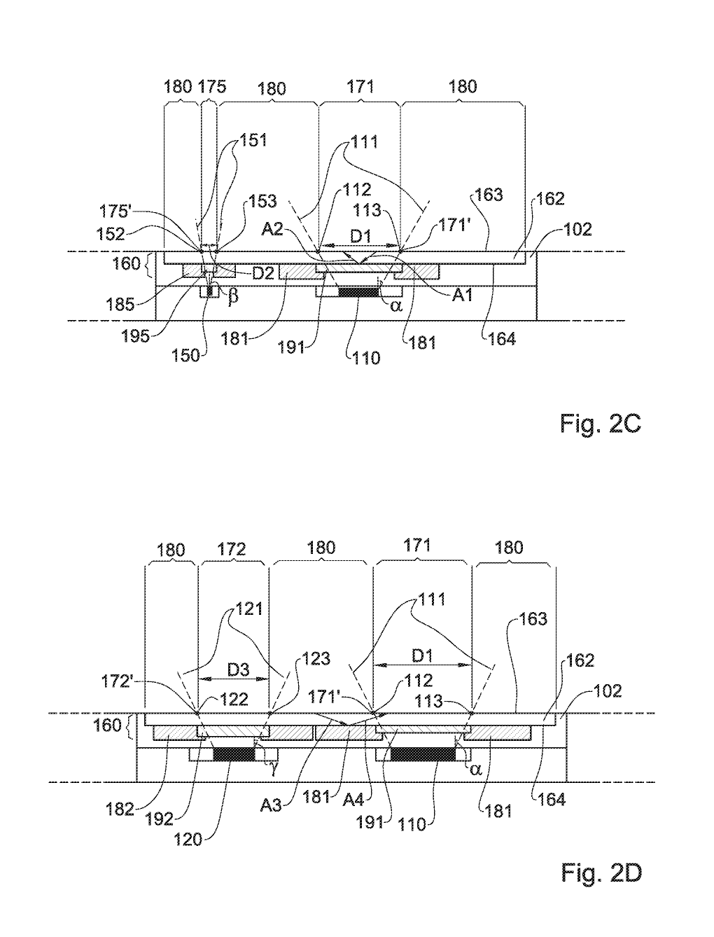

FIGS. 2A-2D, 3A-3C and 4A-4C illustrate different examples of the presently disclosed subject matter. These examples present various configurations of one or more light-absorbing layers and, optionally, one or more anti-reflection layers that are applied to the cover member of the cover window, for reducing, or even eliminating, the influence of the above described crosstalks. It should be indicated that the light-absorbing layers and the anti-reflection layers are thinner by an order of magnitude than what is illustrated in FIGS. 2A-2D, 3A-3C and 4A-4B, and they are illustrated with increased width for illustration purposes only.

Reference is now made to FIGS. 2A-2D in which a first example of the presently disclosed subject matter is shown.

FIGS. 2A and 2B illustrate a mobile phone 100 including: a housing 102; five optical components including: a camera 110, a flash-light 120, a Time-of-Flight (TOF)+Ambient Light Sensor (ALS) IR emitter 130, an ALS receiver 140 and a TOF receiver 150; and a cover window 160 mounted to the housing 102 for covering the optical components 110, 120, 130, 140 and 150.

Each of the optical components of the present disclosure has an electronic chip with an optical sensor mounted thereon, and each such optical sensor has a viewing cone. Therefore, when reference below is made to viewing cones of the camera 110, the flash-light 120, the Time-of-Flight (TOF)+Ambient Light Sensor (ALS) IR emitter 130, the ALS receiver 140 and the TOF receiver 150, the intention is to refer to the viewing cone of the sensor of each of these optical components.

As shown in FIG. 2B, the cover window 160 comprises:
a cover member 162 having a top surface 163 and an opposite bottom surface 164 (shown in FIG. 2C) facing the optical components 110, 120, 130, 140 and 150;
five light transmitting regions 171, 172, 173, 174 and 175, each disposed in registry with a viewing cone of its respective optical component of the optical components 110, 120, 130, 140 and 150, and a peripheral region 180 extending between the light transmitting regions 171, 172, 173, 174 and 175 and disposed outside the viewing cone of the respective optical components 110, 120, 130, 140 and 150;
three light-absorbing layers 181, 182 and 183 applied to the bottom surface 164 at a portion of the peripheral region 180; and
five anti-reflection layers 191, 192, 193, 194 and 195, applied to the bottom surface 164 at the light transmitting regions 171, 172, 173, 174 and 175, respectively.

The light-absorbing layers 181, 182 and 183 and the anti-reflection layers 191, 192, 193, 194 and 195 can be seen in FIG. 2B since the cover member 162 is transparent.

The light-absorbing layers 181, 182 and 183 are made of Carbon and the anti-reflection layers 191, 192, 193, 194 and 195 are made of Alumina and Silica, and the cover member 162 is made of Sapphire.

The light transmitting regions 171, 172, 173, 174 and 175 are defined by circles 171′, 172′, 173′, 174′ and 175′, respectively. The diameter of each of the circles 171′, 172′, 173′, 174′ and 175′ is substantially equal to the diameter of a circle generated by intersecting the viewing cone of each of optical components 110, 120, 130, 140 and 150, with the top surface 163, respectively.

According to the particular configuration of the cover window 160, there are one or more light absorbing layers between each two of the optical components 110, 120, 130, 140 and 150 and their respective light transmitting regions 171, 172, 173, 174 and 175. This configuration allows absorbing light that travels from one optical component to another optical component, and thereby reducing crosstalks between these optical components.

The light-absorbing layer 181 has a ring-like shape enclosing the anti-reflection layer 191, the light-absorbing layer 182 has a ring-like shape enclosing the anti-reflection layer 192, and the light-absorbing layer 183 has an oval external shape enclosing the round anti-reflection layers 193, 194 and 195.

In general, the light-absorbing layers 181, 182 and 183 are configured for absorbing light that is travelling via the cover member 162 at the peripheral region 180, thereby reducing the amount of light that is travelling via the cover member 162 toward the optical components 110, 120, 130, 140 and 150. This allows reducing crosstalks of the optical components 110, 120, 130, 140 and 150 with each other and between the optical components 110, 120, 130, 140 and 150 and the exterior surrounding of the top surface 163. Moreover, the anti-reflection layers 191, 192, 193, 194 and 195 are configured for reducing reflectance of light that escapes from the cover member 162 at the bottom surface 164, thereby reducing the amount of light that is left within the cover member 162 and travels via the cover member 162 toward those optical components 110, 120, 130, 140 and 150 which should not receive that light. This also allows reducing crosstalks between the optical components 110, 120, 130, 140 and 150 themselves and between each of the optical components 110, 120, 130, 140 and 150 and the exterior surrounding of the top surface 163.

Reference is now particularly made to FIG. 2C, in which a cross-sectional view of the camera 110, the TOF receiver 150, and the cover window 160 at the area therebetween is illustrated.

The camera 110 has a viewing cone 111 with a viewing angle α of about 45°. The viewing cone 111 intersects with the top surface 163 at points 112 and 113, the distance between which is D1. The distance D1 is a diameter of the circle 171′ (shown in FIG. 2B) that defines the boundaries of the light transmitting region 171. Therefore, the light transmitting region 171 is disposed in registry with the viewing cone 111 of the camera 110. The anti-reflection layer 191 is applied to the bottom surface 164, so as to reduce the reflectance of the cover window 160 at the light transmitting region 171 from R=14.2% to R=7.9%, and respectively increase the transmission of light at the light transmitting region 171 from T=85.6% to T=92.0%. For example, when a ray of light A1 travelling from the cover member 162 towards the camera 110 reaches the bottom surface 164, so due to the existence of the anti-reflection layer 191, only 0.25% of A1 is reflected into the cover window 162, as indicated by ray of light A2. Therefore, less light is left within the cover window 162 for travelling therein toward the TOF receiver 150, and crosstalks with the TOF receiver 150 are eliminated. If the anti-reflection layer 191 was non existant, so 7.7% of A1 would have been reflected into the cover member 162.

The light absorbing layer 181 has an absorbance coefficient of 99.8%. Therefore, when light that is travelling within the cover window 162 at the peripheral region 180 reaches the light absorbing layer 181, 99.8% of this light is absorbed at the light absorbing layer 181. In other words, if the light is travelling toward the camera 110, most of it will be absorbed at the light absorbing layer 181 before reaching the light transmitting region 171, and if light is travelling from the light transmitting region 171 via the light absorbing layer 181 toward the TOF receiver 150, most of it will be absorbed at the light absorbing layer 181 before reaching the light transmitting region 175.

The TOF receiver 150 has a viewing cone 151 with a viewing angle β of about 12.5°. The viewing cone 151 intersects with the top surface 163 at points 152 and 153, the distance between which is D2. The distance D2 is a diameter of the circle 175′ (shown in FIG. 2B) that defines the boundaries of the light transmitting region 175. Therefore, the light transmitting region 175 is disposed in registry with the viewing cone of the TOF receiver 150. The anti-reflection layer 195 is applied to the bottom surface 164, so as to reduce the reflectance of the cover window 160 at the light transmitting region 175 from R=−14.2% to R=7.9%, and respectively increase the transmission of light at the light transmitting region 175 from T=85.6% to T=92.0%. This allows more light to escape from the cover member 162 toward the TOF receiver 150 at the light transmitting region 175.

The light absorbing layer 183 has an absorbance coefficient of 99.8%. Therefore, when light that is travelling within the cover window 162 at the peripheral region 180 reaches the light absorbing layer 183, 99.8% of this light is absorbed at the light absorbing layer 183. In other words, if the light is travelling toward the TOF receiver 150, most of it will be absorbed at the light absorbing layer 183 before reaching the light transmitting region 175, and if light is travelling from the light transmitting region 175 via the light absorbing layer 183 toward the camera 110, most of it will be absorbed at the light absorbing layer 183 before reaching the light transmitting region 171.

Reference is now particularly made to FIG. 2D, in which a cross-sectional view of the camera 110, the flash-light 120, and the cover window 160 at the area therebetween is illustrated.

FIG. 2D illustrates the camera 110 of FIG. 2C and the respective elements of the cover window 160 related to the camera 110, i.e., the viewing cone 111, the angle α, the points 112 and 113, the distance D1, the circle 171′, the light transmitting region 171, light absorbing layer 181, and the anti-reflection layer 191.

Therefore, when a ray of light A3 originally created by the flash-light 120 travels within the cover window 162 toward the camera 110 reaches the light absorbing layer 181, 99.8% of this light is absorbed at the light absorbing layer 181, and only 0.2% thereof indicated by ray of light A4 will continue toward the camera 110. In other words, if the light is travelling toward the camera 110, most of it will be absorbed at the light absorbing layer 181 before reaching the light transmitting region 171, and if light is travelling from the light transmitting region 171 via the light absorbing layer 181 toward the flash-light 120, most of it will be absorbed at the light absorbing layer 181 before reaching the light transmitting region 172.

The flash-light 120 has a viewing cone 121 with a viewing angle γ of about 45°. The viewing cone 121 intersects with the top surface 163 at points 122 and 123, the distance between which is D3. The distance D3 is a diameter of the circle 172′ (shown in FIG. 2B) that defines the boundaries of the light transmitting region 172. Therefore, the light transmitting region 172 is disposed in registry with the viewing cone of the flash-light 120. The anti-reflection layer 192 is applied to the bottom surface 164, so as to reduce the reflectance of the cover window 160 at the light transmitting region 172 from R=14.2% to R=7.9%, and respectively increase the transmission of light at the light transmitting region 172 from T=85.6% to T=92.0%. This allows more light to escape from the cover member 162 from the flash-light 120 at the light transmitting region 172.

The light absorbing layer 182 has an absorbance coefficient of 99.8%. Therefore, when light that is travelling within the cover window 162 at the peripheral region 180 reaches the light absorbing layer 182, 99.8% of this light is absorbed at the light absorbing layer 182. In other words, if the light is travelling toward the flash-light 120, most of it will be absorbed at the light absorbing layer 182 before reaching the light transmitting region 172, and if light is travelling from the light transmitting region 172 via the light absorbing layer 182 toward the camera 110, most of it will be absorbed at the light absorbing layer 182 before reaching the light transmitting region 171.

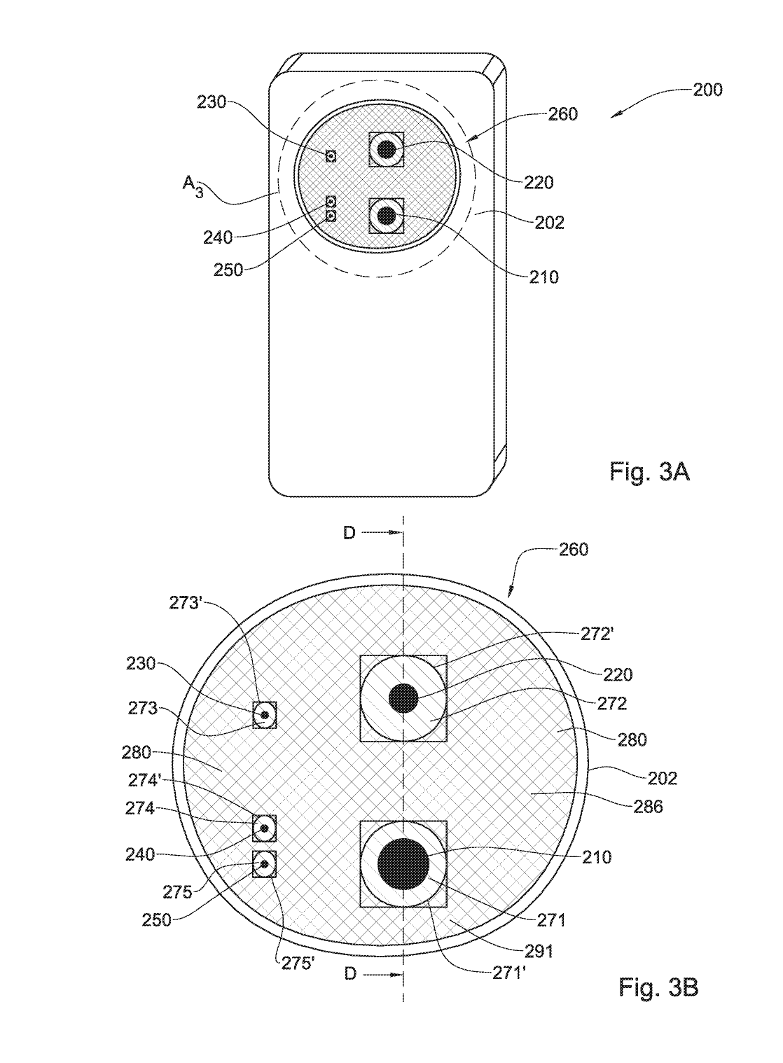

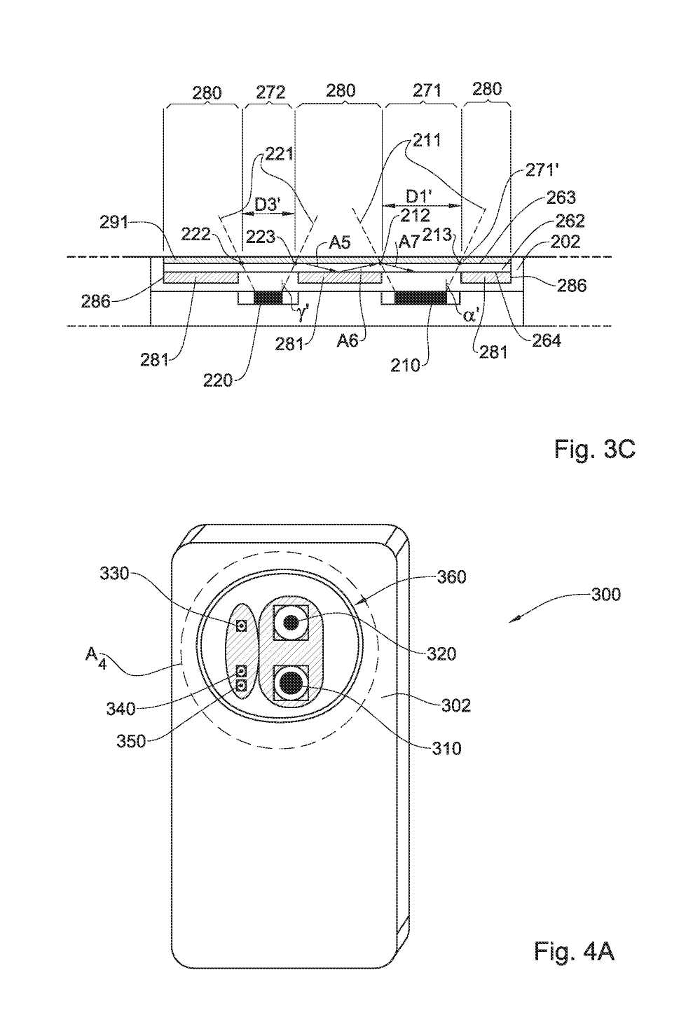

Reference is now made to FIGS. 3A-3C in which a second example of the presently disclosed subject matter is shown.

FIGS. 3A and 3B illustrate a mobile phone 200 including: a housing 202; five optical components including: a camera 210, a flash-light 220, a Time-of-Flight (TOF)+Ambient Light Sensor (ALS) IR emitter 230, an ALS receiver 240 and a TOF receiver 250; and a cover window 260 mounted to the housing 202 for covering the optical components 210, 220, 230, 240 and 250.

The only difference between the mobile phone 100 and the mobile phone 200 is in the structure of the cover window 260 which is different from that of the cover window 160. The rest of the components of the mobile phone 100 are identical to those of the mobile phone 200.

As shown in FIGS. 3B and 3C, the cover window 260 comprises:
a cover member 262 having a top surface 263 and an opposite bottom surface 264 (shown in FIG. 3C) facing the optical components 210, 220, 230, 240 and 250;
five light transmitting regions 271, 272, 273, 274 and 275, each disposed in registry with a viewing cone of its respective optical component of the optical components 210, 220, 230, 240 and 250, and a peripheral region 280 extending between the light transmitting regions 271, 272, 273, 274 and 275 and disposed outside the viewing cone of the respective optical components 210, 220, 230, 240 and 250;
a light-absorbing layer 281 applied to the bottom surface 264 at the entire area of the peripheral region 280; and
an anti-reflection layer 291 applied to the top surface 263 at the light transmitting regions 271, 272, 273, 274 and 275 and at the entire area of the peripheral region 280.

The light-absorbing layer 281 can be seen in FIG. 3B since the anti-reflection layer 291 and the cover member 262 are transparent.

The light-absorbing layer 281 is made of Carbon and the anti-reflection layer 291 is made of Alumina and Silica. The cover member 262 is made of Sapphire.

The light transmitting regions 271, 272, 273, 274 and 275 are defined by circles 271′, 272′, 273′, 274′ and 275′, respectively. The diameter of each of the circles 271′, 272′, 273′, 274′ and 275′ is substantially equal to the diameter of a circle generated by intersecting the viewing cone of each of optical components 210, 220, 230, 240 and 250, with the top surface 263, respectively.

According to the particular configuration of the cover window 260, there is a light absorbing layer between each two of the optical components 210, 220, 230, 240 and 250 and their respective light transmitting regions 271, 272, 273, 274 and 275. This configuration allows absorbing light that travels from one optical component to another optical component, and thereby reducing crosstalks between these optical components.

In general, the light-absorbing layer 281 is configured for absorbing light that is travelling via the cover member 262 at the peripheral region 280, thereby reducing the amount of light that is travelling via the cover member 262 toward the optical components 210, 220, 230, 240 and 250 and reducing crosstalks of the optical components 210, 220, 230, 240 and 250 with each other and between the optical components 210, 220, 230, 240 and 250 and the exterior surrounding of the top surface 263. Moreover, the anti-reflection layer 291 is configured for reducing reflectance of light that is directed from the interior of the cover member 262 toward the top surface 263, thereby allowing more light to escape from the cover member 262 and reducing the amount of light that is travelling via the cover member 262 toward those optical components 210, 220, 230, 240 and 250 which should not receive that light. The existence of the light-absorbing layer 281 and the anti-reflection layer 291 reduces crosstalks between the optical components 210, 220, 230, 240 and 250 themselves and between each of the optical components 210, 220, 230, 240 and 250 and the exterior surrounding of the anti-reflection layer 291.

Reference is now particularly made to FIG. 3C, in which a cross-sectional view of the camera 210, the flash-light 220, and the cover window 260 at the area therebetween is illustrated.

The camera 210 has a viewing cone 211 with a viewing angle α′ of about 45°. The viewing cone 211 intersects with the top surface 263 at points 212 and 213, the distance between which is D1′. The distance D1′ is a diameter of the circle 271′ (shown in FIG. 3B) that defines the boundaries of the light transmitting region 271. Therefore, the light transmitting region 271 is disposed in registry with the viewing cone 211 of the camera 210. The anti-reflection layer 291 is applied to the top surface 263, so as to reduce the reflectance of the cover window 260 at top surface 263 from R=7.7% to R=0.25%, and respectively increase the transmission of light at the top surface 263 from T=92.3% to T=99.75%. This allows more light that is travelling in the cover member 262 to escape therefrom to the exterior of the anti-reflection layer 291, and as a result of that less light will reach the optical component that should not receive that light.

The light absorbing layer 281 has a substantially round external outline 286 and five round internal outlines defined by the circles 271′, 272′, 273′, 274′, each defining a hollow space that encloses the respective light transmitting region of the light transmitting regions and is applied to the bottom surface 264. The light absorbing layer 281 has an absorbance coefficient of 99.8%. Therefore, when light that is travelling within the cover window 262 at the peripheral region 280 reaches the light absorbing layer 281, 99.8% of this light is absorbed at the light absorbing layer 281. In other words, if the light is travelling toward the camera 210, most of it will be absorbed at the light absorbing layer 281 before reaching the light transmitting region 271, and if light is travelling from the light transmitting region 271 via the cover member 262 toward the flash-light 220, most of it will be absorbed at the light absorbing layer 281 before reaching the light transmitting region 272.

Therefore, when a ray of light A5 originally created by the flash-light 220 travels within the cover window 262 toward the camera 210 and reaches the light absorbing layer 281, so 99.8% of this light will be absorbed at the light absorbing layer 281, and only 0.2% thereof indicated by ray of light A6 will continue toward the camera 210. However, when the ray of light A6 will reach the top surface 263, due to the anti-reflection layer 291, 0.25% thereof will be reflected into the cover window 262, and 0.25% thereof will continue to the camera 210. This reflected ray of light is indicated by A7 in FIG. 3C. This example presents how the existence of both the anti-reflection layer 291 and the light absorbing layer 281 dramatically reduced the amount of light that travels within the cover member 262 toward the camera 210. According to the particular example, due to the anti-reflection layer 291 and the light absorbing layer 281, the value of A5 is reduced by 99.95%, when A7 is analyzed.

In other words, if the light is travelling toward the camera 210, most of it will be absorbed at the light absorbing layer 281 and will escape from the cover member to the exterior of the anti-reflection layer 291 before reaching the light transmitting region 271, and if light is travelling from the light transmitting region 271 via the light absorbing layer 281 toward the flash-light 220, most of it will be absorbed at the light absorbing layer 181 and will escape from the cover member to the exterior of the anti-reflection layer 291 before reaching the light transmitting region 272.

The flash-light 220 has a viewing cone 221 with a viewing angle γ′ of about 45°. The viewing cone 221 intersects with the top surface 263 at points 222 and 223, the distance between which is D3′. The distance D3′ is a diameter of the circle 272′ (shown in FIG. 3B) that defines the boundaries of the light transmitting region 272. Therefore, the light transmitting region 272 is disposed in registry with the viewing cone of the flash-light 220.

If the light is travelling toward the flash-light 220, most of it will be absorbed at the light absorbing layer 281 before reaching the light transmitting region 272 and will escape from the cover member when reaching the top surface 263 with the aid of the anti-reflection layer 291.

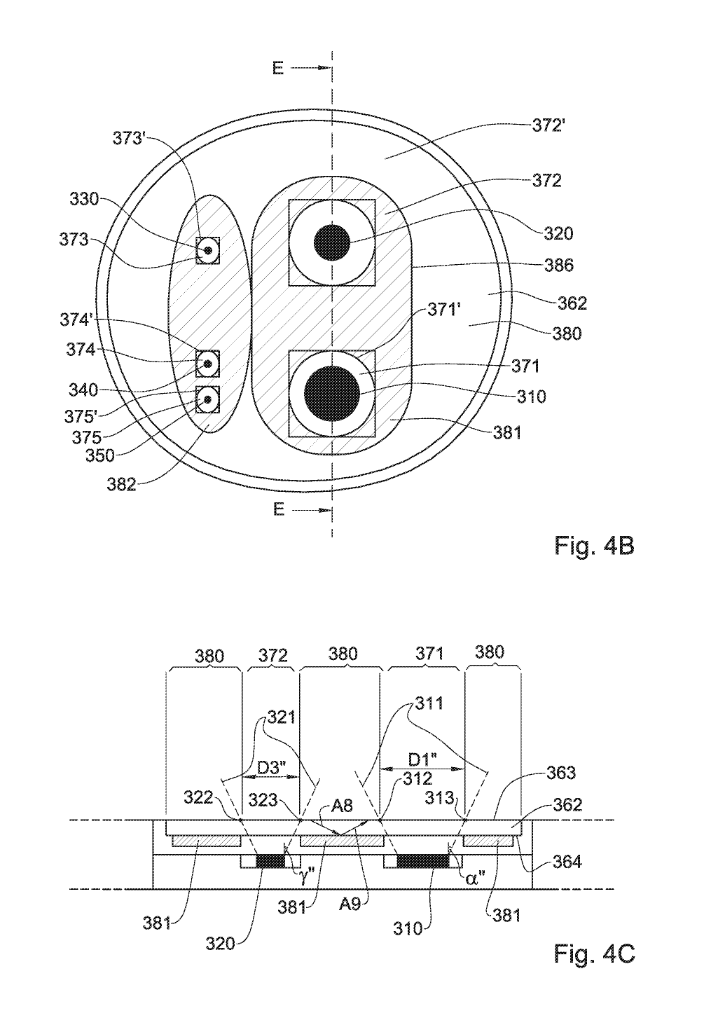

Reference is now made to FIGS. 4A-4C in which a third example of the presently disclosed subject matter is shown.

FIGS. 4A and 4B illustrate a mobile phone 300 including: a housing 302; five optical components including: a camera 310, a flash-light 320, a Time-of-Flight (TOF)+Ambient Light Sensor (ALS) IR emitter 330, an ALS receiver 340 and a TOF receiver 350; and a cover window 360 mounted to the housing 302 for covering the optical components 310, 320, 330, 340 and 350.

The only difference between the mobile phones 100 and 200 and the mobile phone 300 is in the structure of the cover window 360 which is different from that of the cover windows 160 and 260. The rest of the components of the mobile phones 100 and 200 are identical to those of the mobile phone 300.

As shown in FIGS. 4B and 4C, the cover window 360 comprises:
a cover member 362 having a top surface 363 and an opposite bottom surface 364 (shown in FIG. 4C) facing the optical components 310, 320, 330, 340 and 350;
five light transmitting regions 371, 372, 373, 374 and 375, each disposed in registry with a viewing cone of its respective optical component of the optical components 310, 320, 330, 340 and 350, and a peripheral region 380 extending between the light transmitting regions 371, 372, 373, 374 and 375 and disposed outside the viewing cone of the respective optical components 310, 320, 330, 340 and 350; and
two light-absorbing layers 381 and 382 applied to the bottom surface 364 at a portion of the peripheral region 380.

The cover window 360 does not include an anti-reflection layer.

The light-absorbing layers 381 and 382 can be seen in FIG. 4B since the cover member 362 is transparent.

The light-absorbing layers 381 and 382 are made of Carbon and the cover member 362 is made of Sapphire.

The light transmitting regions 371, 372, 373, 374 and 375 are defined by circles 371′, 372′, 373′, 374′ and 375′, respectively. The diameter of each of the circles 371′, 372′, 373′, 374′ and 375′ is substantially equal to the diameter of a circle generated by intersecting the viewing cone of each of optical components 310, 320, 330, 340 and 350, with the top surface 363, respectively.

According to the particular configuration of the cover window 360, there is a light absorbing layer between each two of the optical components 310, 320, 330, 340 and 350 and their respective light transmitting regions 371, 372, 373, 374 and 375. This configuration allows absorbing light that travels from one optical component to another optical component, and thereby reducing crosstalks between these optical components.

In general, the light-absorbing layers 381 and 382 are configured for absorbing light that is travelling via the cover member 362 at the peripheral region 380, thereby reducing the amount of light that is travelling via the cover member 362 toward the optical components 310, 320, 330, 340 and 350 and reducing crosstalks of the optical components 310, 320, 330, 340 and 350 with each other and between the optical components 310, 320, 330, 340 and 350 and the exterior surrounding of the top surface 363.

Reference is now particularly made to FIG. 4C, in which a cross-sectional view of the camera 310, the flash-light 320, and the cover window 360 at the area therebetween is illustrated.

The camera 310 has a viewing cone 311 with a viewing angle α″ of about 45°. The viewing cone 211 intersects with the top surface 363 at points 312 and 313, the distance between which is D1″. The distance D1″ is a diameter of the circle 371′ (shown in FIG. 4B) that defines the boundaries of the light transmitting region 371. Therefore, the light transmitting region 371 is disposed in registry with the viewing cone 311 of the camera 310.

The light absorbing layer 281 has a substantially oval external outline 386 and two internal round outlines defined by the circles 371′ and 372′, each defining a hollow space that encloses the respective light transmitting region and is applied to the bottom surface 364. The light absorbing layer 381 has an absorbance coefficient of 99.8%. Therefore, when light that is travelling within the cover window 362 at the peripheral region 380 reaches the light absorbing layer 381, 99.8% of this light is absorbed at the light absorbing layer 381. In other words, if the light is travelling toward the camera 310, most of it will be absorbed at the light absorbing layer 381 before reaching the light transmitting region 371, and if light is travelling from the light transmitting region 371 via the light absorbing layer 381 toward the flash-light 320, most of it will be absorbed at the light absorbing layer 381 before reaching the light transmitting region 372.

Therefore, when a ray of light A8 originally created by the flash-light 320 travels within the cover window 362 toward the camera 310 reaches the light absorbing layer 381, 99.8% of this light is absorbed at the light absorbing layer 381, and only 0.2% thereof indicated by ray of light R9 will continue toward the camera 310.

In other words, if the light is travelling toward the camera 310, most of it will be absorbed at the light absorbing layer 381, and if light is travelling from the light transmitting region 371 via the light absorbing layer 381 toward the flash-light 320, most of it will be absorbed at the light absorbing layer 381.

As shown in FIG. 4B, the light absorbing layer 382 has an oval external outline, and three internal outlines defined by circles 373′, 374′ and 375′ that enclose the light transmitting regions 373, 374 and 375, respectively.

The flash-light 320 has a viewing cone 321 with a viewing angle γ″ of about 45°. The viewing cone 321 intersects with the top surface 363 at points 322 and 323, the distance between which is D3″. The distance D3″ is a diameter of the circle 372′ (shown in FIG. 4B) that defines the boundaries of the light transmitting region 372. Therefore, the light transmitting region 372 is disposed in registry with the viewing cone of the flash-light 320.

If the light is travelling toward the flash-light 320, most of it will be absorbed at the light absorbing layer 381 before reaching the light transmitting region 372 and will later escape from the cover member 362 when reaching the top surface 363.

1.-40. (canceled)

41. A cover window for covering two or more optical components of a device, said cover window comprising:
a cover member having a top surface and a bottom surface configured for facing the optical components, when said cover member is mounted to said device;
at least two light transmitting regions, each disposed in registry with a viewing cone of a respective optical component;
and at least one peripheral region extending between the two light transmitting regions and disposed outside the viewing cone of the respective optical components; and
a light-absorbing layer disposed at least at a portion of the peripheral region.

42. The cover window according to claim 41, wherein the light-absorbing layer is applied to the cover member.

43. The cover window according to claim 41, wherein the light-absorbing layer is disposed at an area of the peripheral region which is disposed between the light transmitting regions.

44. The cover window according to claim 41, wherein the light-absorbing layer is disposed at an area that encloses said light transmitting regions.

45. The cover window according to claim 41, wherein the light-absorbing layer is constituted by two or more separate light-absorbing layers, each defined by an internal outline defining a hollow space that encloses the respective light transmitting region of the light transmitting regions.

46. The cover window according to claim 41, wherein when said cover window is mounted to the device, the peripheral region is disposed at least above a spacing extending between the optical components.

47. The cover window according to claim 41, wherein the light-absorbing layer is applied to the bottom surface of the cover member.

48. The cover window according to claim 41, further comprising at least one anti-reflection layer applied to at least one of said bottom surface and said top surface of the cover member.

49. A device comprising two or more optical components and a cover window mounted thereto for covering the optical components, the cover window comprising:
a cover member having a top surface and a bottom surface configured for facing the optical components, when said cover member is mounted to said device;
at least two light transmitting regions, each disposed in registry with a viewing cone of a respective optical component;
and at least one peripheral region extending between the two light transmitting regions and disposed outside the viewing cone of the respective optical components; and
a light-absorbing layer disposed at least at a portion of the peripheral region.

50. The device according to claim 49, wherein the light-absorbing layer is applied to the cover member.

51. The device according to claim 49, wherein the light-absorbing layer is disposed at an area of the peripheral region which is disposed between the light transmitting regions.

52. The device according to claim 51, wherein the light-absorbing layer is defined by an external outline having two concave portions, each partially surrounding the respective light transmitting region of the light transmitting regions.

53. The device according to claim 49, wherein the light-absorbing layer is disposed at an area that encloses said light transmitting regions.

54. The device according to claim 49, wherein when said cover window is mounted to the device, the peripheral region is disposed at least above a spacing extending between the optical components.

55. The device according to claim 49, wherein the light-absorbing layer is applied to the bottom surface of the cover member.

56. The device according to claim 49, further comprising at least one anti-reflection layer applied to at least one of said bottom surface and said top surface of the cover member.

57. A method for producing a cover window for covering two or more optical components of a device, the method comprising steps of:
obtaining a cover member having a top surface and a bottom surface configured for facing the optical components, when said cover member is mounted to said device;
defining at least two light transmitting regions, each disposed in registry with a viewing cone of a respective optical component;
defining at least one peripheral region between the two light transmitting regions and disposed outside the viewing cone of the respective optical components; and
disposing a light-absorbing layer at least at a portion of the peripheral region.

58. The method according to claim 57, wherein said step of disposing the light-absorbing layer is performed by applying light-absorbing layer to the cover member.

59. The method according to claim 57, wherein said step of disposing the light-absorbing layer is performed by disposing the light-absorbing layer at an area of the peripheral region between the light transmitting regions.

60. The method according to claim 58, wherein said step of disposing a light-absorbing layer is performed by applying the light-absorbing layer to the bottom surface of the cover member.
